(19) United States
(12) Patent Application Publication
(10) Pub. No.: US 2025/0267701 A1
(43) Pub. Date: Aug. 21, 2025

(54) Access Point Coordinated Opportunistic Secondary Channel Access

(71) Applicant: Apple Inc., Cupertino, CA (US)

(72) Inventors: Morteza Mehrnoush, Hayward, CA (US); Wook Bong Lee, San Jose, CA (US); Ahmad Reza Hedayat, Carlsbad, CA (US); Oren Shani, Saratoga, CA (US); Yong Liu, Campbell, CA (US); Anuj Batra, Redwood City, CA (US)

(21) Appl. No.: 18/978,263

(22) Filed: Dec. 12, 2024

Related U.S. Application Data
(60) Provisional application No. 63/555,697, filed on Feb. 20, 2024.

(51) Int. Cl. H04W 74/08

(52) U.S. Cl. CPC H04W 74/08

(57) ABSTRACT

This disclosure relates to methods for access point coordinated opportunistic secondary channel access in a wireless local area network. Overlapping basic service set transmission may be detected on a primary channel of a link between wireless devices. A transmit opportunity may be initiated on a secondary channel of the link based at least in part on detection of the overlapping basic service set transmission on the primary channel of the link. The transmit opportunity may be initiated with an initial control frame, and a control response frame may be provided in response to the initial control frame. The control response frame may indicate that the transmit opportunity responder has a different preferred duration or bandwidth than indicated by the initial control frame.

### PRIORITY INFORMATION

This application claims priority to U.S. Provisional Patent Application No. 63/555,697, entitled “Access Point Coordinated Opportunistic Secondary Channel Access,” filed Feb. 20, 2024, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### TECHNICAL FIELD

The present application relates to wireless communication, including techniques and devices for access point coordinated opportunistic secondary channel access in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), may take the form of smart phones or tablets that a user typically carries. One aspect of wireless communication that may commonly be performed by mobile devices may include wireless networking, for example over a wireless local area network (WLAN), which may include devices that operate according to one or more communication standards in the IEEE 802.11 family of standards.

In a wireless local area network setting, it may be possible that overlapping basic service sets can co-exist using partially or fully overlapping frequency ranges. When overlapping basic service set activity is present on only a portion of the operating range for a WLAN, leaving the remainder of the operating range unused may represent an inefficient use of network resources. Accordingly, improvements in the field are desired.

### SUMMARY

Embodiments are presented herein of, inter alia, systems, apparatuses, and methods for access point coordinated opportunistic secondary channel access in a wireless local area network architecture.

A wireless device may include one or more antennas, one or more radios operably coupled to the one or more antennas, and a processor operably coupled to the one or more radios. The wireless device may be configured to establish a connection with an access point through a wireless local area network (WLAN) over one or multiple wireless links, or may be an access point configured to establish a connection with one or more other wireless devices through a WLAN over one or multiple wireless links. The wireless device may operate in each of the multiple wireless links using a respective radio of the one or more radios.

When overlapping basic service set (OBSS) activity is present on part (e.g., a primary channel) but not all of the bandwidth of a given link, it may be possible for wireless devices to opportunistically make use of the unused portion of the bandwidth (e.g., a secondary channel) to perform wireless communication. According to the techniques described herein, an access point (or a transmit opportunity initiator peer in a peer-to-peer system) may be able to coordinate such opportunistic secondary channel access with another wireless device.

To coordinate the opportunistic secondary channel access, the access point may determine the duration and bandwidth of the OBSS activity, and select a secondary channel TXOP bandwidth and duration accordingly. The access point may provide an initial control frame to a TXOP responder wireless device (e.g., a non-access point station in a basic service set of the access point) to indicate the determined duration and bandwidth of the TXOP on the secondary channel.

The TXOP responder may have the opportunity to indicate a different TXOP bandwidth and/or duration, for example in case the TXOP responder detects different OBSS that requires a smaller bandwidth and/or shorter duration TXOP on the secondary channel. In this case, the secondary channel access may be adjusted accordingly, or may be terminated.

Techniques are also described herein for handling scenarios in which the OBSS activity terminates early, as well as techniques for handling scenarios when the TXOP initiator and TXOP responder have equal operating bandwidth and when the TXOP initiator and TXOP responder have different operating bandwidths, among various other techniques.

The techniques described herein may be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a flowchart diagram illustrating an example method for performing access point coordinated opportunistic secondary channel access in a wireless local area network, according to some embodiments;

FIG. 5 illustrates example aspects of a possible scenario in which a primary channel is occupied and a secondary channel is unoccupied in a wireless local area network setting, according to some embodiments;

FIG. 6 illustrates example aspects of a possible scenario in which AP coordinated opportunistic secondary channel access is used while a primary channel is occupied in a wireless local area network setting, according to some embodiments;

FIGS. 7-16 illustrate example aspects of various possible scenarios in which AP coordinated opportunistic secondary channel access is used with a STA with equal bandwidth capability as the AP in a wireless local area network setting, according to some embodiments;

FIGS. 17-20 illustrate example aspects of various possible scenarios for handling early termination of OBSS activity during AP coordinated opportunistic secondary channel access in a wireless local area network setting, according to some embodiments; and

FIGS. 21-23 illustrate example aspects of various possible scenarios in which AP coordinated opportunistic secondary channel access is used with a STA with smaller bandwidth capability than the AP in a wireless local area network setting, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium-Any of various types of non-transitory memory devices or storage devices. The term “memory medium” is intended to include; any computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers, portable gaming devices, laptops, wearable devices (e.g., smart watch, smart glasses), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile), or may be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors may include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology may also be referred to as “Wi-Fi” or “wireless local area network (WLAN)” technology.

Configured to-Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

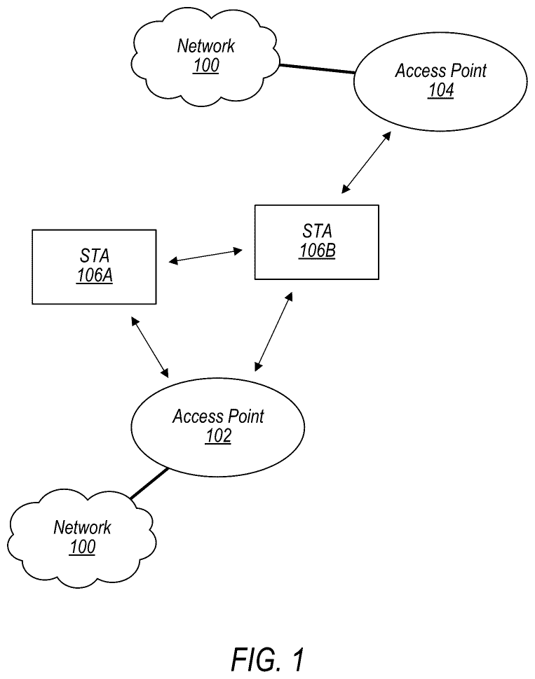

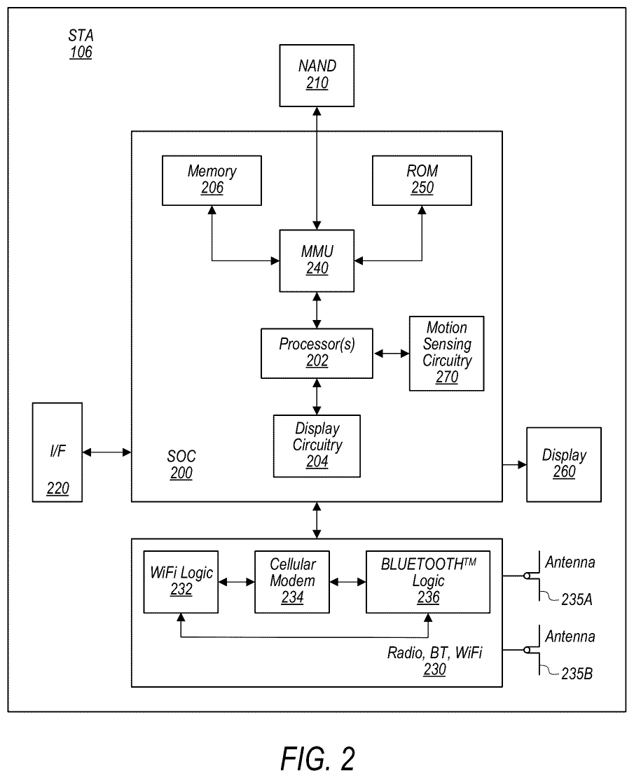

### FIGS. 1-2—Wireless Communication System

FIG. 1 illustrates an example of a wireless communication system. It is noted that FIG. 1 represents one possibility among many, and that features of the present disclosure may be implemented in any of various systems, as desired. For example, embodiments described herein may be implemented in any type of wireless device. The wireless embodiment described below is one example embodiment.

As shown, the exemplary wireless communication system includes an access point (AP) 102, which communicates over a transmission medium with one or more wireless devices 106A, 106B, etc. Wireless devices 106A and 106B may be user devices, such as stations (STAs), non-AP STAs, or WLAN devices.

The STA 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The STA 106 may include a processor (processing element) that is configured to execute program instructions stored in memory. The STA 106 may perform any of the method embodiments described herein by executing such stored instructions. Alternatively, or in addition, the STA 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The AP 102 may be a stand-alone AP or an enterprise AP, and may include hardware that enables wireless communication with the STA devices 106A and 106B. The AP 102 may also be equipped to communicate with a network 100 (e.g., a WLAN, an enterprise network, and/or another communication network connected to the Internet, among various possibilities). Thus, the AP 102 may facilitate communication among the STA devices 106 and/or between the STA devices 106 and the network 100. AP 102 can be configured to provide communications over one or more wireless technologies, such as any or 802.11 a, b, g, n, ac, ad, ax, ay, be and/or other 802.11 versions, or a cellular protocol, such as 5G or LTE, including in in an unlicensed band.

The communication area (or coverage area) of the AP 102 may be referred to as a basic service area (BSA) or cell. The AP 102 and the STAs 106 may be configured to communicate over the transmission medium using any of various radio access technologies (RATs) or wireless communication technologies, such as Wi-Fi, LTE, LTE-Advanced (LTE-A), 5G NR, ultra-wideband (UWB), etc.

AP 102 and other similar access points (not shown) operating according to one or more wireless communication technologies may thus be provided as a network, which may provide continuous or nearly continuous overlapping service to STA devices 106A-B and similar devices over a geographic area, e.g., via one or more communication technologies. A STA may roam from one AP to another AP directly, or may transition between APs and cellular network cells.

Note that at least in some instances a STA device 106 may be capable of communicating using any of multiple wireless communication technologies. For example, a STA device 106 might be configured to communicate using Wi-Fi, LTE, LTE-A, 5G NR, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, according to some embodiments, wireless devices may be able to connect to either or both of AP 102 (or a cellular base station) and the access point 104 (or another access point) to access the network 100. For example, a STA may roam from AP 102 to AP 104 based on one or more factors, such as coverage, interference, and capabilities. Note that it may also be possible for the AP 104 to provide access to a different network (e.g., an enterprise Wi-Fi network, a home Wi-Fi network, etc.) than the network to which the AP 102 provides access.

The STAs 106A and 106B may include handheld devices such as smart phones or tablets, wearable devices such as smart watches or smart glasses, and/or may include any of various types of devices with wireless communication capability. For example, one or more of the STAs 106A and/or 106B may be a wireless device intended for stationary or nomadic deployment such as an appliance, measurement device, control device, etc.

The STA 106B may also be configured to communicate with the STA 106A. For example, the STA 106A and STA 106B may be capable of performing direct device-to-device (D2D) communication. In some embodiments, such direct communication between STAs may also or alternatively be referred to as peer-to-peer (P2P) communication. The direct communication may be supported by the AP 102 (e.g., the AP 102 may facilitate discovery, among various possible forms of assistance), or may be performed in a manner unsupported by the AP 102. Such P2P communication may be performed using 3GPP-based D2D communication techniques, Wi-Fi-based P2P communication techniques, UWB, BT, and/or any of various other direct communication techniques, according to various embodiments.

The STA 106 may include one or more devices or integrated circuits for facilitating wireless communication, potentially including a Wi-Fi modem, cellular modem, and/or one or more other wireless modems. The wireless modem(s) may include one or more processors (processor elements) and various hardware components as described herein. The STA 106 may perform any of (or any portion of) the method embodiments described herein by executing instructions on one or more programmable processors. For example, the STA 106 may be configured to perform techniques for access point coordinated opportunistic secondary channel access in a wireless communication system, such as according to the various methods described herein. Alternatively, or in addition, the one or more processors may be one or more programmable hardware elements such as an FPGA (field-programmable gate array), application-specific integrated circuit (ASIC), or other circuitry, that is configured to perform any of the method embodiments described herein, or any portion of any of the method embodiments described herein. The wireless modem(s) described herein may be used in a STA device as defined herein, a wireless device as defined herein, or a communication device as defined herein. The wireless modem described herein may also be used in an AP, a base station, a pico cell, a femto cell, or other similar network side device.

The STA 106 may include one or more antennas for communicating using two or more wireless communication protocols or radio access technologies. In some embodiments, the STA device 106 can be configured to communicate using a single shared radio. The shared radio may couple to a single antenna, or may couple to multiple antennas (e.g., for MIMO) for performing wireless communications. Alternatively, the STA device 106 may include two or more radios, each of which may be configured to communicate via a respective wireless link. Other configurations are also possible.

### FIG. 2—Example Block Diagram of a STA Device

FIG. 2 illustrates one possible block diagram of a STA device, such as STA 106. In some instances, the STA 106 may additionally or alternatively be referred to as a UE 106. STA 106 also may be referred to as a non-AP STA 106. As shown, the STA 106 may include a system on chip (SOC) 200, which may include one or more portions configured for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 200 may include processor(s) 202 which may execute program instructions for the STA 106, and display circuitry 204 which may perform graphics processing and provide display signals to the display 260. The SOC 200 may also include motion sensing circuitry 270 which may detect motion of the STA 106, for example using a gyroscope, accelerometer, and/or any of various other motion sensing components. The processor(s) 202 may also be coupled to memory management unit (MMU) 240, which may be configured to receive addresses from the processor(s) 202 and translate those addresses to locations in memory (e.g., memory 206, read only memory (ROM) 250, flash memory 210). The MMU 240 may be configured to perform memory protection and page table translation or set up. In some embodiments, the MMU 240 may be included as a portion of the processor(s) 202.

As shown, the SOC 200 may be coupled to various other circuits of the STA 106. For example, the STA 106 may include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, Bluetooth, Wi-Fi, NFC, GPS, UWB, etc.).

The STA 106 may include at least one antenna, and, in some embodiments, multiple antennas 235A and 235B, for performing wireless communication with base stations and/or other devices. For example, the STA 106 may use antennas 235A and 235B to perform the wireless communication. As noted above, the STA 106 may, in some embodiments, be configured to communicate wirelessly using a plurality of wireless communication standards or radio access technologies (RATs).

The wireless communication circuitry 230 may include a Wi-Fi modem 232, a cellular modem 234, and a Bluetooth modem 236. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 may be a cellular modem capable of performing cellular communication according to one or more cellular communication technologies, e.g., in accordance with one or more 3GPP specifications.

As described herein, STA 106 may include hardware and software components for implementing embodiments of this disclosure. For example, one or more components of the wireless communication circuitry 230 (e.g., Wi-Fi modem 232, cellular modem 234, BT modem 236) of the STA 106 may be configured to implement part or all of the methods for access point coordinated opportunistic secondary channel access described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit).

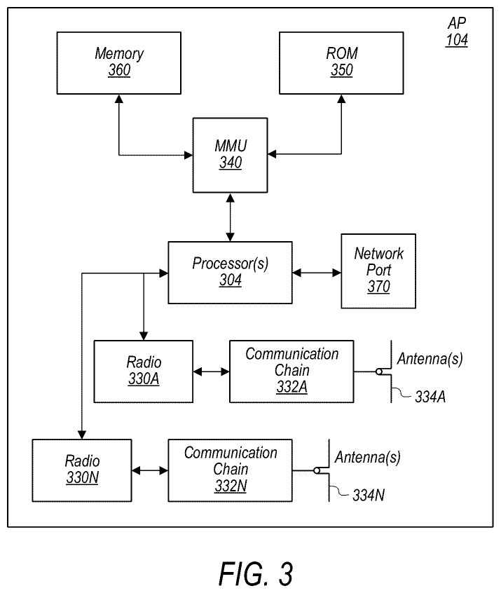

### FIG. 3—Block Diagram of an Access Point

FIG. 3 illustrates an example block diagram of an access point (AP) 104, according to some embodiments. In some instances (e.g., in an 802.11 communication context), the AP 104 may also be referred to as a station (STA), and possibly more particularly as an AP STA. It is noted that the AP of FIG. 3 is merely one example of a possible access point. As shown, AP 104 may include processor(s) 304, which may execute program instructions for the AP 104. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The AP 104 may include at least one network port 370. The network port 370 may be configured to couple to a network and provide multiple devices, such as STA devices 106, with access to the network, for example as described herein above in FIG. 1.

The network port 370 (or an additional network port) may also or alternatively be configured to couple to a cellular network, e.g., a core network of a cellular service provider. The core network may provide mobility related services and/or other services to a plurality of devices, such as wireless devices 106. In some cases, the network port 370 may couple to a telephone network via the core network, and/or the core network may provide a telephone network (e.g., among other wireless devices serviced by the cellular service provider).

The AP 104 may include one or more radios 330A-330N, each of which may be coupled to a respective communication chain and at least one antenna 334, and possibly multiple antennas. The antenna(s) 334 may be configured to operate as a wireless transceiver and may be further configured to communicate with wireless devices 106 via radio 330. The antenna(s) 334A-N communicate with their respective radios 330A-N via communication chains 332A-N. Communication chains 332 may be receive chains, transmit chains, or both. The radios 330A-N may be configured to communicate in accordance with various wireless communication standards, including, but not limited to, LTE, LTE-A, 5G NR, UWB, Wi-Fi, BT, etc. The AP 104 may be configured to operate on multiple wireless links using the one or more radios 330A-N, wherein each radio is used to operate on a respective wireless link.

The AP 104 may be configured to communicate wirelessly using multiple wireless communication standards. In some instances, the AP 104 may include multiple radios, which may enable the network entity to communicate according to multiple wireless communication technologies. For example, as one possibility, the AP 104 may include a 4G or 5G radio for performing communication according to a 3GPP wireless communication technology as well as a Wi-Fi radio for performing communication according to Wi-Fi. In such a case, the AP 104 may be capable of operating as both a cellular base station and a Wi-Fi access point. As another possibility, the AP 104 may include a multi-mode radio, which is capable of performing communications according to any of multiple wireless communication technologies (e.g., 5G NR and Wi-Fi, 5G NR and LTE, etc.). As still another possibility, the AP 104 may be configured to act exclusively as a Wi-Fi access point, e.g., without cellular communication capability.

As described further herein, the AP 104 may include hardware and software components for implementing or supporting implementation of features described herein, such as access point coordinated opportunistic secondary channel access, among various other possible features. The processor 304 of the AP 104 may be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 may be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 may be configured to implement, or support implementation of, part or all of the features described herein.

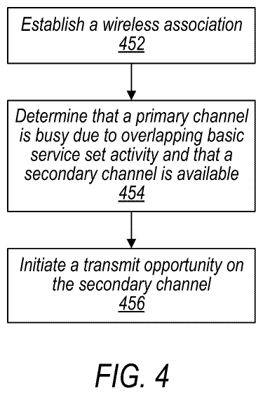

### FIG. 4—Access Point Coordinated Opportunistic Secondary Channel Access

FIG. 4 is a flowchart diagram illustrating a method for supporting access point coordinated opportunistic secondary channel access in a WLAN, according to some embodiments. In various embodiments, some of the elements of the methods shown may be performed concurrently, in a different order than shown, may be substituted for by one or more other method elements, or may be omitted. Additional method elements may also be performed as desired.

Aspects of the method of FIG. 4 may be implemented by a wireless device, such as an AP 104 or STA 106 illustrated in and described with respect to FIGS. 1-3, or more generally in conjunction with any of the computer circuitry, systems, devices, elements, or components shown in the Figures, among others, as desired. For example, a processor (and/or other hardware) of such a device may be configured to cause the device to perform any combination of the illustrated method elements and/or other method elements.

Note that while at least some elements of the method of FIG. 4 are described in a manner relating to the use of communication techniques and/or features associated with IEEE 802.11 specification documents, such description is not intended to be limiting to the disclosure, and aspects of the method of FIG. 4 may be used in any suitable wireless communication system, as desired. As shown, the methods may operate as follows.

At least two wireless devices may establish a wireless association (452). The wireless association may be established using Wi-Fi, wireless communication techniques that are based at least in part on Wi-Fi, and/or any of various other wireless communication technologies, according to various embodiments. For example, an access point (AP) wireless device may provide beacon transmissions including information for associating with the AP wireless device, and one or more other wireless devices (e.g., non-AP wireless devices) may request to associate with the AP wireless device using the information provided in the beacon transmissions, as one possibility. Such an association may also be referred to as an infrastructure link, in some embodiments. As another example, a peer-to-peer (P2P) association may be formed between the wireless devices, e.g., using Wi-Fi P2P based communication techniques and/or other P2P communication technology. Such an association may also be referred to as a P2P link, in some embodiments. Variations and/or other techniques for establishing an association are also possible.

The AP wireless device may provide wireless local area network functionality to associated wireless devices, and/or the peer wireless devices may provide P2P wireless local area network functionality with each other, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device and/or by the peer devices.

One or more of the wireless devices may determine that a primary channel of a link between the wireless devices is busy due to overlapping basic service set (OBSS) activity and that a secondary channel of the link is available (idle) (454). The OBSS activity may include a transmission that is detected on the primary channel via channel/energy sensing, and/or via preamble detection and decoding, in some embodiments. Note that the observation of OBSS activity could be the same for both wireless devices (e.g., in a scenario in which both are within range of the device performing the OBSS transmission), or could be different for the wireless devices (e.g., in a scenario in which each wireless device is within range of a different OBSS).

A transmit opportunity (TXOP) may be initiated on the secondary channel (456) of the link. The TXOP initiator may be an AP wireless device, or possibly a TXOP initiator peer device of a P2P pair, according to various embodiments. The TXOP may be initiated based at least in part on detecting the OBSS activity on the primary channel, for example to make more efficient use of the unused portion (e.g., the secondary channel) of the link. Note that leaving coordination of this opportunistic secondary channel access to the AP wireless device may reduce the likelihood of any other STAs in the same system attempting to initiate a TXOP with the AP on the primary channel (e.g., due to the AP having its network allocation vector (NAV) set) during the TXOP on the secondary channel, at least in some instances.

The TXOP initiator may receive an indication of a duration of the detected OBSS transmission. For example, information in an initial control frame (ICF) of the OBSS transmission, and/or information in preamble information (e.g., L-SIG length, TXOP duration field, possibly in combination with other control information) of a data physical layer protocol data unit (PPDU) may be received by the TXOP initiator, and used to determine or estimate the duration of the OBSS transmission. A network allocation vector (NAV) for the TXOP may be selected based at least in part on the indication of the duration of the OBSS transmission. For example, the NAV may be selected to not extend beyond the duration of the OBSS transmission. This may increase the likelihood that the wireless devices will be available when the primary channel becomes available again, at least in some instances.

The TXOP initiator may also determine a bandwidth of the OBSS transmission, and/or a signal strength of the OBSS transmission. For example, the bandwidth and/or signal strength (e.g., received signal strength indicator (RSSI)) may be determined based on energy sensing or channel sensing on the primary channel. As another possibility, the bandwidth could be determined using information included in an initial control frame and/or preamble information for the OBSS transmission. A bandwidth for the TXOP may be selected based at least in part on the bandwidth and/or signal strength of the OBSS transmission. For example, the bandwidth may be selected to not overlap with the bandwidth of the OBSS transmission, and possibly further to leave a gap (e.g., one or more punctured sub-channels) between the TXOP on the secondary channel and the OBSS transmission on the primary channel, e.g., in case of high signal strength for the OBSS transmission, in order to reduce the potential impact of adjacent channel interference (ACI) on both the potential activity on the secondary channel during the TXOP and on the OBSS transmission on the primary channel.

The TXOP initiator may initiate the TXOP by transmitting an ICF for the TXOP. The ICF may indicate the selected NAV for the TXOP (e.g., using control information included in the ICF) and/or the selected bandwidth for the TXOP (e.g., using control information included in the ICF and/or the transmission bandwidth of the ICF). In some embodiments, the ICF may include a multi-user request-to-send (MU-RTS) frame. The TXOP may be initiated using a secondary channel anchor sub-channel. In some embodiments, the furthest sub-channel of the secondary channel from the OBSS transmission on the primary channel may be used as the anchor sub-channel of the secondary channel. This may reduce the potential impact of interference from OBSS transmission on the primary channel on the anchor sub-channel, at least in some instances.

The TXOP responder (e.g., a non-AP STA wireless device or a wireless device in a P2P pair) may transmit a control response frame to the TXOP initiator in response to the ICF. In some embodiments, the control response frame may include a clear-to-send (CTS) frame.

The control response frame may confirm the TXOP responder's availability for the TXOP, e.g., if the TXOP responder is available. In some instances, the TXOP responder may indicate its own preferred TXOP duration and/or TXOP bandwidth, which may differ from the TXOP duration and TXOP bandwidth indicated in the ICF. For example, if the TXOP responder is observing different OBSS activity than the TXOP initiator, which could have a different duration and/or bandwidth, than the TXOP responder may identify that a different TXOP duration and/or TXOP bandwidth would be preferred, e.g., to avoid causing interference to the OBSS activity observed by the TXOP responder, and/or to avoid the TXOP on the secondary channel extending after the OBSS activity observed by the TXOP responder on the primary channel is complete. The preferred TXOP duration of the TXOP responder may be indicated using control information included in the control response frame, in some embodiments. The preferred TXOP bandwidth of the TXOP responder may also be indicated using control information included in the control response frame, in some embodiments. Alternatively, or in addition, the preferred TXOP bandwidth of the TXOP responder may be indicated using the transmission bandwidth of the control response frame (e.g., the transmission bandwidth may be set to the preferred bandwidth), in some embodiments.

As another possibility, in some embodiments, the control response frame may indicate a request to terminate the TXOP on the secondary channel. Such a response could be provided, for example, in case of high signal strength for the OBSS activity detected by the TXOP responder, e.g., if the signal strength is sufficient as to be likely to cause (and/or be impacted by) high ACI for the TXOP on the secondary channel.

As another possibility, in some scenarios it may be possible that the TXOP responder does not actually respond to the ICF. For example, in some embodiments, it may be the case that a STA is configured to only respond to TXOP initiation on a secondary channel of a link when it has a NAV set for the primary channel of the link. In such a scenario, if the TXOP responder does not detect OBSS activity (e.g., if it is not within range to receive the same OBSS transmission that the TXOP initiator detects), it may be the case that the TXOP responder does not respond to the ICF.

When the TXOP responder accepts the TXOP request (e.g., sends a control response frame indicating that that the TXOP responder is available for the TXOP, with or without requested adjustment to the TXOP duration and/or TXOP bandwidth), the TXOP initiator and the TXOP responder may proceed to perform communication during the TXOP on the secondary channel. This may include downlink (e.g., from the TXOP initiator to the TXOP responder) and/or uplink (e.g., from the TXOP responder to the TXOP initiator) data communication, according to various embodiments.

In some instances, it may be possible that one or both of the TXOP initiator or the TXOP responder can determine that the primary channel of the link is idle during the TXOP on the secondary channel. For example, the OBSS activity could be terminated early, for any of various possible reasons. This could be detected by performing a priority interframe space (PIFS) check to determine whether the primary channel is still occupied during some or all frame exchanges during the TXOP on the secondary channel, e.g., using a main or auxiliary radio of the TXOP initiator and/or the TXOP responder. As another possibility, the TXOP responder may be able to listen on the primary channel using an auxiliary radio while receiving (e.g., a data PPDU or other frame) on the secondary channel. In case the TXOP responder detects that the primary channel is idle, the TXOP responder may provide an indication in its next acknowledgement frame to the TXOP initiator to terminate the TXOP. In case the TXOP initiator detects that the primary channel is idle, or if the TXOP initiator receives an indication from the TXOP responder to terminate the TXOP, the TXOP initiator may transmit a control frame (e.g., CF-End) to the TXOP responder to terminate the TXOP.

Note that it can be possible for the wireless devices to have equal operating bandwidth, or for the wireless devices to have different operating bandwidths. For example, in some instances, it may be possible that a STA wireless device has a smaller operating bandwidth than an AP wireless device. In such a scenario, the STA could have a main radio and an auxiliary radio, such that the STA may be able to monitor both the primary channel and the secondary channel, even if the STA can only operate with the main radio on one or the other of the primary channel or the secondary channel. The AP may be aware of the STA configuration and potential need for switching time when switching main radio operation between the primary channel and the secondary channel; for example, the STA could provide capability information, device type information, or other information that is indicative of such a need under applicable circumstances. In this case, when the AP wireless device provides the ICF on the secondary channel, it may be the case that the ICF includes padding that is configured for use by the STA wireless device for channel switching from the primary channel of the link to the secondary channel of the link. The STA wireless may receive the ICF with an auxiliary radio, and perform channel switching with the main radio accordingly to be able to transmit the control response frame with the main radio.

Thus, according to the method of FIG. 4, it may be possible for an AP wireless device (or TXOP initiator in a P2P link) to opportunistically obtain secondary channel access when the primary channel of a link is occupied with overlapping basic service set activity. This secondary channel access may improve spectrum use efficiency in a wireless local area networking communication system, in such a way that is unlikely to meaningfully interfere with or otherwise impact the overlapping basic service set activity, at least according to some embodiments.

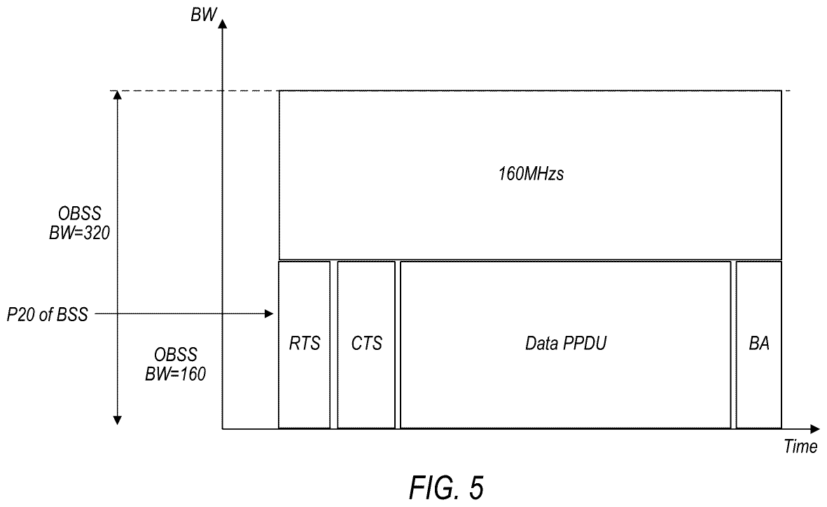

### FIGS. 5-23 and Additional Information

FIGS. 5-23 illustrate further aspects that might be used in conjunction with the method of FIG. 4 if desired. It should be noted, however, that the exemplary details illustrated in and described with respect to FIGS. 5-23 are not intended to be limiting to the disclosure as a whole: numerous variations and alternatives to the details provided herein below are possible and should be considered within the scope of the disclosure.

In a Wi-Fi based communication system, when the primary channel is busy, it may be useful to find a way to use the remaining clear spectrum to improve efficiency (e.g., achieve higher throughput and/or lower latency). FIG. 5 illustrates an example of such a scenario, in which the lower 160 MHz of a 320 MHz basic service set (BSS) is occupied with overlapping BSS (OBSS) activity, while the upper 160 MHz of the 320 MHz BSS is clear. There may be multiple possible assumptions for the bandwidth of the AP and the STAs in such a BSS in which it may be possible to use opportunistic secondary channel access (OSCA). One possible assumption could include that the AP and the STA have the same operating bandwidth, in which case there may be no need for the STA to perform frequency switching to the secondary channel to use OSCA. Another possible assumption could include that the STA has smaller operating bandwidth than the AP, in which case it may be necessary for a STA to perform frequency switching to the secondary channel to use OSCA. In some embodiments, it may be possible that a STA is capable of concurrent energy detection and preamble detection, but only has one SIG decoder available. Other arrangements may also be possible.

In various scenarios, it can be possible that an AP and STAs have different observations of the transmission on the primary channel. For example, different network allocation vector (NAV) observations, different NAV durations, different bandwidth observations, and/or other aspects may differ between different devices in a wireless communication system, in various scenarios. Because of this, an AP and STAs could choose to use different parts of the system bandwidth, or different transmission opportunity durations, which could cause unexpected behaviors if not accounted for.

One possible approach to attempt to mitigate such unexpected behavior may include making use of a framework in which the AP coordinates the secondary channel TXOP with the STAs. When the AP sets its NAV, it may be the case that STAs cannot initiate any TXOP with the AP on the primary channel. The AP can initiate the TXOP on the secondary channel (SC) and coordinate the SC TXOP duration and bandwidth (BW) with the STAs for both downlink and trigger-based uplink transmission. Note that a similar approach (e.g., with coordination by the TXOP initiator) can be used for peer-to-peer (P2P) purposes as well, at least according to some embodiments.

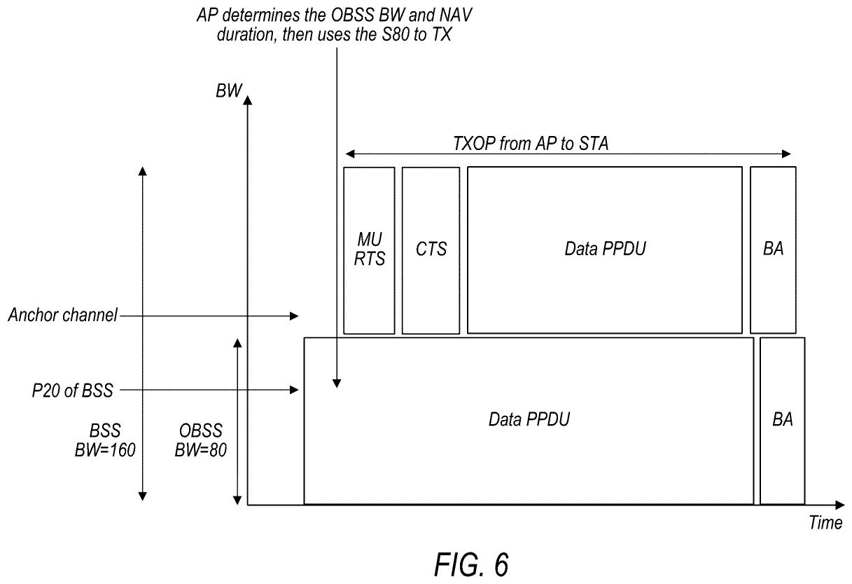

FIG. 6 illustrates example aspects of one possible AP coordinated OSCA transmission, according to some embodiments. As shown, the AP coordinated OSCA transmission may include an AP/STA using the SC to communicate when the primary 20 MHz (P20) of the BSS for an AP is busy due to OBSS activity. The STA/AP may determine the bandwidth and NAV duration for the OSCA based on the OBSS activity. This can be based on signaling information in an initial control frame (ICF) (e.g., a request-to-send (RTS) frame, such as a multi-user (MU) RTS, among various possibilities) or data physical layer protocol data unit (PPDU) (e.g., if no ICF is used). For example, BW and NAV could be determined based on the (MU-) RTS/CTS at the start of the TXOP. When NAV is not available (e.g., if the TXOP is started without (MU-) RTS/CTS), the OBSS PPDU duration can be used for SC usage, in some embodiments; the STA can use preamble information (e.g., L-SIG length or TXOP duration field (combined with other parameters like BSS color, transmitter address (TA)/receiver address (RA) media access control (MAC) address for determining that the PPDU is OBSS)) to determine the OBSS PPDU duration. Similarly, the BW can be determined from the OBSS PPDU signaling information. It may additionally or alternatively be possible to determine the BW based on channel sensing (e.g., estimating the approximate channel BW based on energy levels), in some embodiments.

If the anchor channel (e.g., the primary 20 MHz sub-channel on the secondary channel) is IDLE, it may be the case that the AP can initiate a TXOP on the SC for trigger-based uplink or downlink communication with a STA. The TXOP on the SC may be selected to end before the NAV duration for the OBSS activity expires, e.g., so that the AP is available on the entire channel when the P20 becomes clear. Since OBSS transmission on the primary and the transmission on the SC can be adjacent, adjacent channel interference (ACI) could be an issue, so it may be useful to leave a frequency separation between the SC BW and the OBSS on the primary channel, at least in some instances.

According to some embodiments, the AP can always initiate the TXOP for OSCA with an ICF (e.g., MU-RTS, as one possibility), which can contain the BW and duration of the TXOP (e.g., given that the anchor channel is already negotiated). The STA may accept the request with the duration and BW of the requested SC usage; from the STA side there may be multiple implementation options. As one possibility, the STA may only respond to the AP when it has a NAV set on the primary channel. As another possibility, the STA can respond to the AP regardless of its own NAV setting (e.g., for better SC usage).

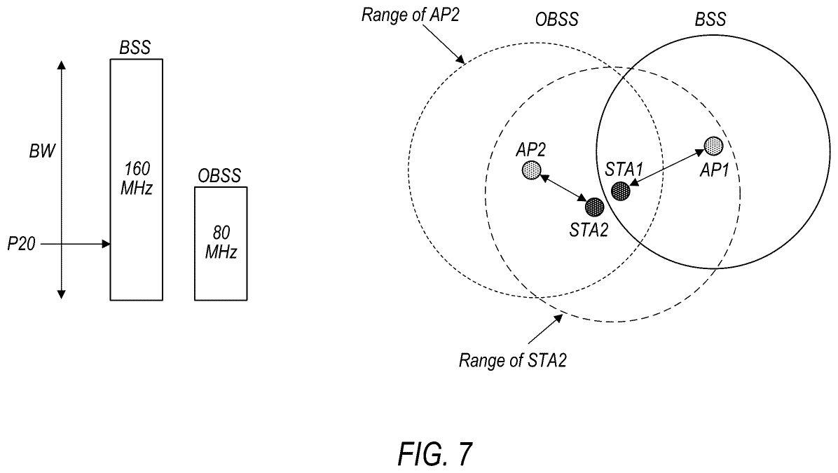

FIG. 7 illustrates example aspects of one possible wireless communication system with overlapping BSS operation. In the illustrated example system, the BSS in which AP1 and STA1 operate is 160 MHz and the OBSS (in which AP2 and STA2 operate) is 80 MHz (e.g., such that there is overlap on the P80 of the BSS). STA1/AP1 can both hear STA2. STA1 can also hear AP2, but AP1 cannot hear AP2.

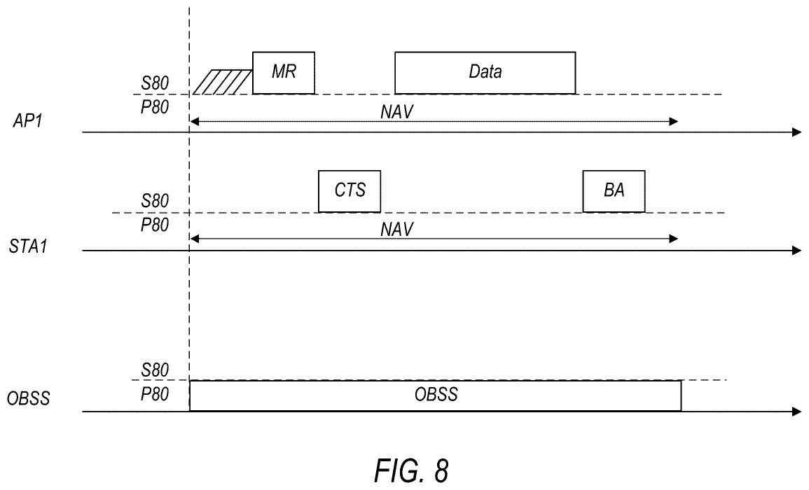

FIG. 8 illustrates example aspects of a possible scenario in which AP coordinated OSCA communication could occur in such a system, according to some embodiments. In this example scenario, STA1 has operating bandwidth equal to AP1. When STA2 sends a data PPDU, both AP1 and STA1 set the same NAV. As shown, AP1 sends a MU-RTS (MR) frame on S80 and STA1 responds with a CTS frame. The TXOP duration on the S80 is set up to the NAV on the primary channel. The AP1 and the STA1 can then communicate data on the S80 during the TXOP.

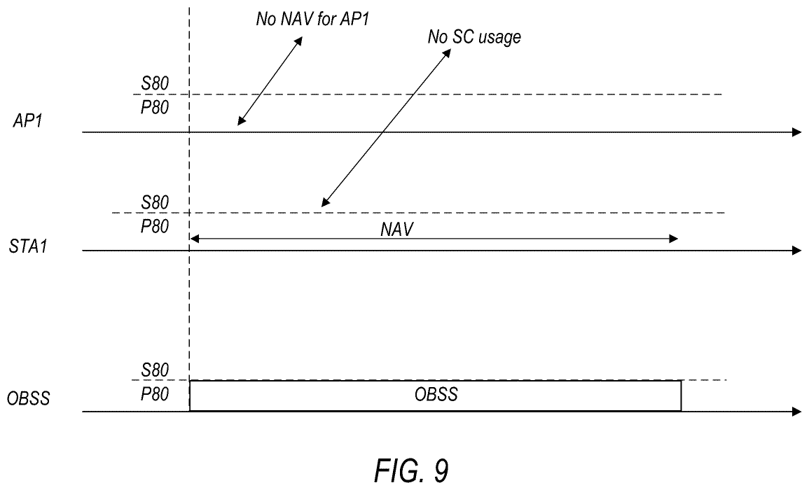

FIG. 9 illustrates example aspects of a possible scenario in which AP coordinated OSCA communication does not occur in such a system, according to some embodiments. In this example scenario, STA1 has operating bandwidth equal to AP1. When AP2 sends a data PPDU, only STA1 will set NAV, while AP1 will think the channel is clear. Thus, AP1 and STA1 have different NAV observations in this scenario. As shown, since AP1 does not have NAV set for the P80, it will not initiate AP coordinated OSCA, and the STA1 won't use the S80 without coordination by AP1.

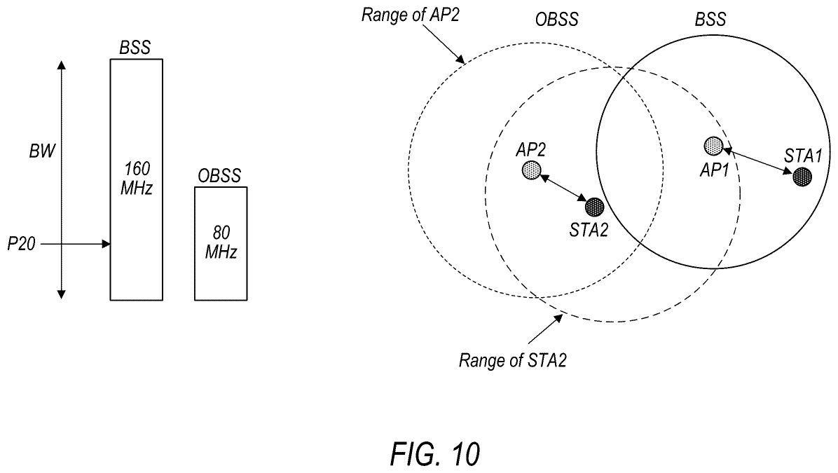

FIG. 10 illustrates example aspects of another possible wireless communication system with overlapping BSS operation. In the illustrated example system, the BSS in which AP1 and STA1 operate is 160 MHz and the OBSS (in which AP2 and STA2 operate) is 80 MHz (e.g., such that there is overlap on the P80 of the BSS). AP1 can hear STA2 but not AP2. STA1 cannot hear AP2 or STA2.

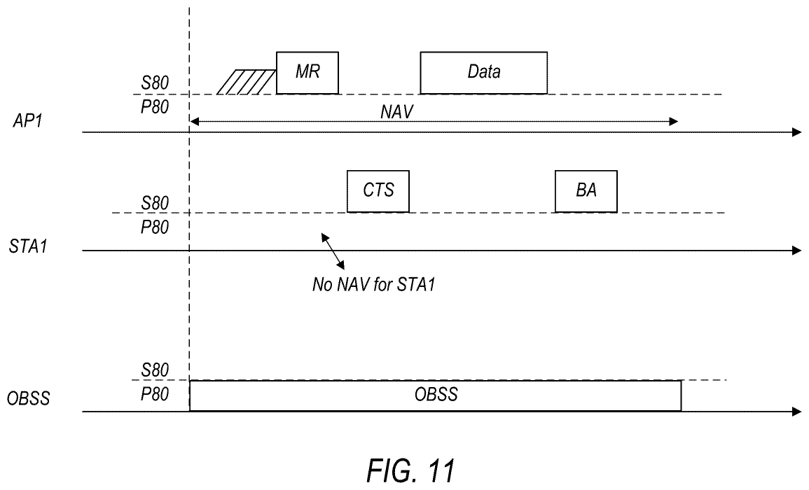

FIG. 11 illustrates example aspects of a possible scenario in which AP coordinated OSCA communication could occur in such a system, according to some embodiments. In this example scenario, STA1 has operating bandwidth equal to AP1. When STA2 sends a data PPDU, AP1 will set NAV, while STA1 will think the channel is clear. Thus, AP1 and STA1 have different NAV observations in this scenario. As shown, AP1 sends a MU-RTS (MR) frame on S80, and since STA1 is IDLE on S80, it responds with a CTS frame (e.g., even though no NAV is set for STA1 on the P80). The TXOP duration on the S80 is set up to the NAV on the primary channel. The AP1 and the STA1 can then communicate data on the S80 during the TXOP.

As noted previously, it may be the case that a STA only uses the SC and responds to a MU-RTS for AP coordinated OSCA when the primary channel NAV is set (e.g., the primary channel is BUSY). As another possibility, when the primary is IDLE at a STA, it can use the auxiliary core (if/when available) on the S80; the STA, upon receiving the MU-RTS on S80, can then use the main radio to respond to the MU-RTS and continue the frame exchange. When the primary is IDLE at STA, another possibility could include the STA using channel statistics on the S80 to determine if the S80 has low clear channel assessment (CCA) or high CCA; if it determines the S80 has low CCA, it can use the preamble decoder for decoding the preamble on both P80 and S80, given that there may be some drawbacks on the performance of the primary channel (e.g., backoff defer and/or blindness).

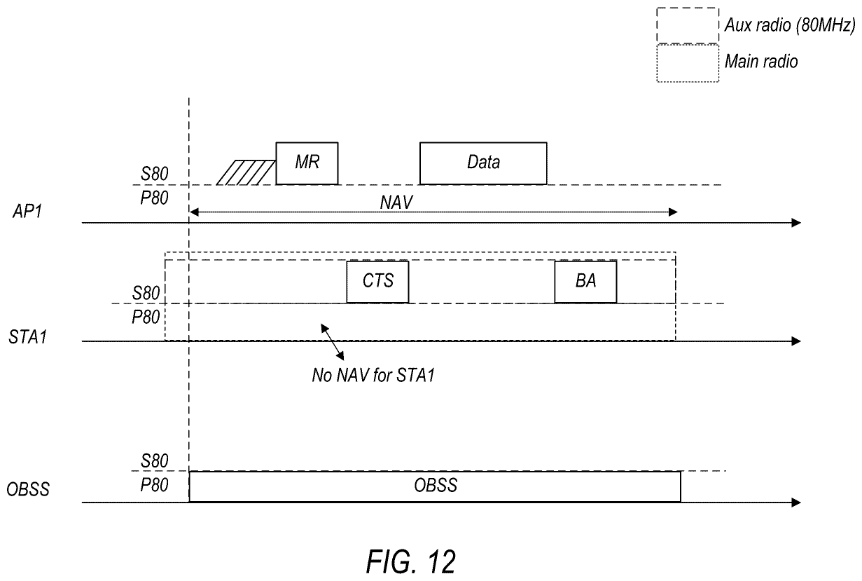

FIG. 12 illustrates a variation of the scenario of FIG. 11, in which an auxiliary radio is available for the STA1 for listening on the S80, according to some embodiments. In this variation, STA1's auxiliary radio operates on the S80, which may help with single preamble decoding, e.g., where otherwise it could cause interruption to the backoff on the primary channel.

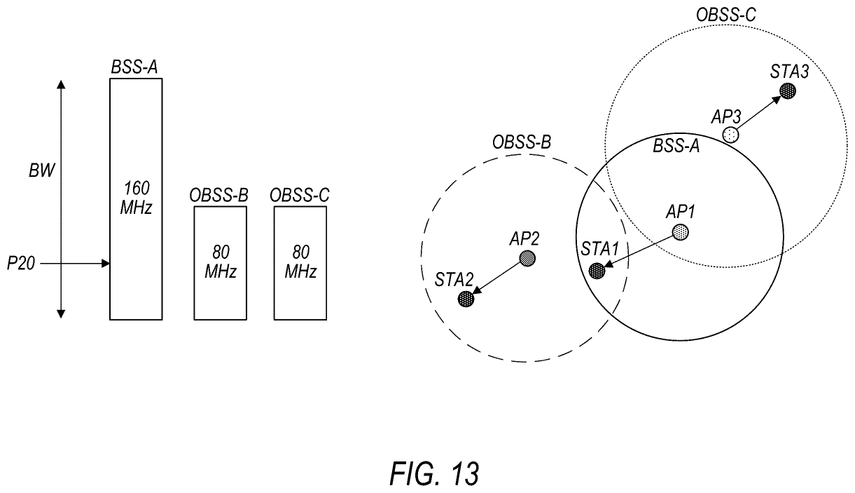

FIG. 13 illustrates example aspects of yet another possible wireless communication system with overlapping BSS operation. In the illustrated example system, the BSS in which AP1 and STA1 operate (“BSS-A”) is 160 MHz, and two OBSS (“OBSS-B,” in which AP2 and STA2 operate, and “OBSS-C,” in which AP3 and STA3 operate) are 80 MHz (e.g., such that there is overlap on the P80 of BSS-A). AP2/STA2 and AP3/STA3 cannot hear each other. STA1 can hear AP2 but not AP3. AP1 can hear AP3 but not AP2.

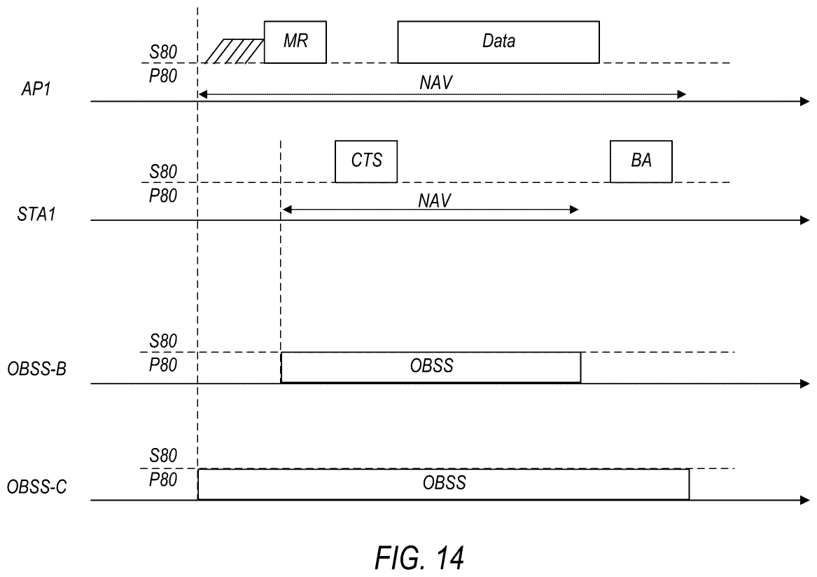

FIG. 14 illustrates example aspects of a possible scenario in which AP coordinated OSCA communication could occur in such a system, according to some embodiments. In this example scenario, STA1 has operating bandwidth equal to AP1. When AP2/STA2 and AP3/STA3 TXOPs overlap, AP1 sets the NAV based on AP3/STA3 and STA1 sets the NAV based on AP2/STA2. Thus, AP1 and STA1 both set NAV, but use different durations, in this example scenario. AP1 initiates the TXOP with STA1, and STA1 can follow the TXOP duration and bandwidth setting of the AP1 regardless of its NAV setting. In some instances, STA1 may decide to change the suggested TXOP duration by the AP1. For example, STA1 may either update the duration in the CTS frame or the (new) CTS frame may carry an additional duration field to indicate the maximum TXOP duration that the responding STA prefers, according to some embodiments.

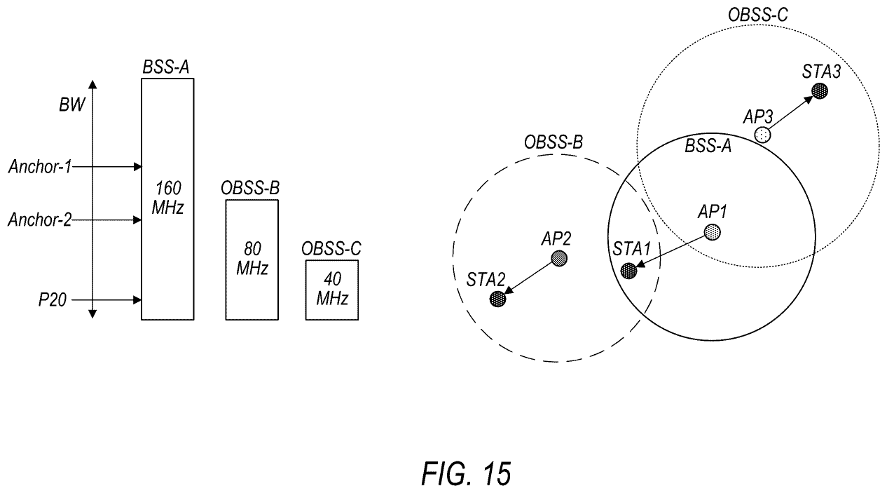

FIG. 15 illustrates example aspects of still another possible wireless communication system with overlapping BSS operation. In the illustrated example system, the BSS in which AP1 and STA1 operate (“BSS-A”) is 160 MHz, another OBSS (“OBSS-B,” in which AP2 and STA2 operate) is 80 MHz, and a further OBSS (“OBSS-C,” in which AP3 and STA3 operate) is 40 MHz (e.g., such that there is overlap on at least the P40 of BSS-A). AP2/STA2 and AP3/STA3 cannot hear each other. STA1 can hear AP2 but not AP3. AP1 can hear AP3 but not AP2.

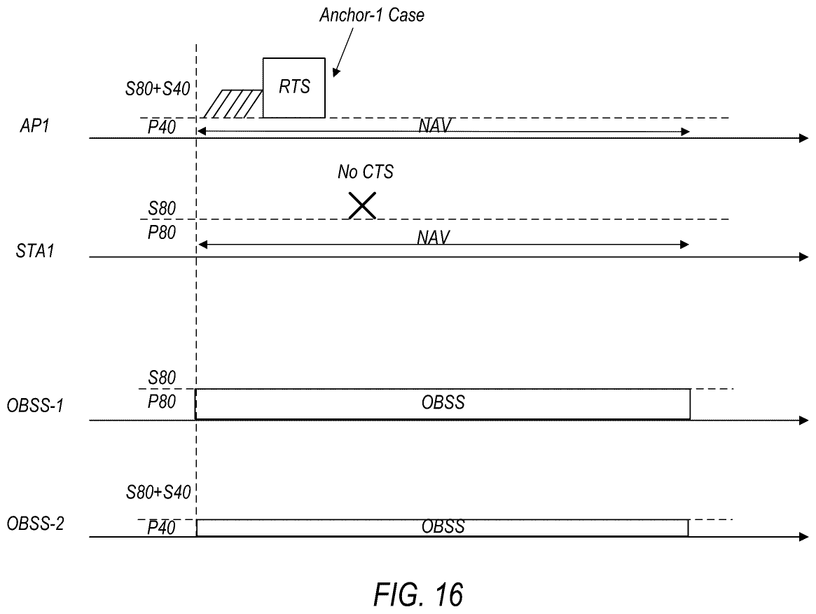

FIG. 16 illustrates example aspects of a possible scenario in which AP coordinated OSCA communication could be attempted in such a system, according to some embodiments. In this example scenario, STA1 has operating bandwidth equal to AP1. AP1 observes OBSS-C on P80, but STA1 observes OBSS-B only on the lower P40 sub-channel. As shown in FIG. 16, in a scenario in which the AP sends RTS on the S120 with primary on Anchor-1, it may be the case that STA1 cannot respond with CTS on S120 because only S80 of STA1 is IDLE. Note also that if AP1 sends RTS on S120 with primary on Anchor-2, it may be the case that STA1 cannot respond with CTS on S120 because Anchor-2 of STA1 is BUSY. In some embodiments, however, STA1 may decide to change the suggested bandwidth by the AP1 for the Anchor-1 case. For example, STA1 may include a new field in a CTS that indicates a subset of the bandwidth suggested by the AP in the preceding MU-RTS, such as to indicate to use only S80 for the TXOP on the secondary channel.

When the secondary channel is used as part of AP coordinated OSCA communication, the ACI from the primary channel may degrade the performance of the TXOP on the secondary channel, and the primary channel may similarly be impacted, e.g., by reciprocity. In scenarios when OBSS ACI is large, it may be possible to try to channel switch or to leave some frequency separation to the OBSS of the P80. To reduce the ACI when using the secondary channel, as one possibility, the anchor channel for the secondary channel may be chosen to be furthest away from the OBSS on the primary channel. Additionally, or alternatively, some frequency separation may be left between the OBSS and the secondary channel bandwidth, for example by puncturing 20 or 40 MHz of the secondary channel. The STA may report the required frequency separation on the secondary channel to facilitate this, or the STA may reduce the bandwidth used when responding to the MU-RTS on the secondary channel. The puncturing of one or more sub-channels of the secondary channel could be semi-static or dynamic, according to various embodiments.

For cases in which the OBSS received signal strength indicator (RSSI) on the P80 is high, an AP may decide to not send the MU-RTS to initiate AP coordinated OSCA, or if the AP sends the MU-RTS, the STA can send a “NO TXOP” signal to the AP to ask for termination of the TXOP. An indication of the high ACI observed can be added in the signaling. Note that if a TXOP is terminated due to no CTS or another control response frame with “NO-TXOP” indicated, any STAs receiving the NAV on the secondary channel can reset their NAV following the NAV timeout, at least in some instances.

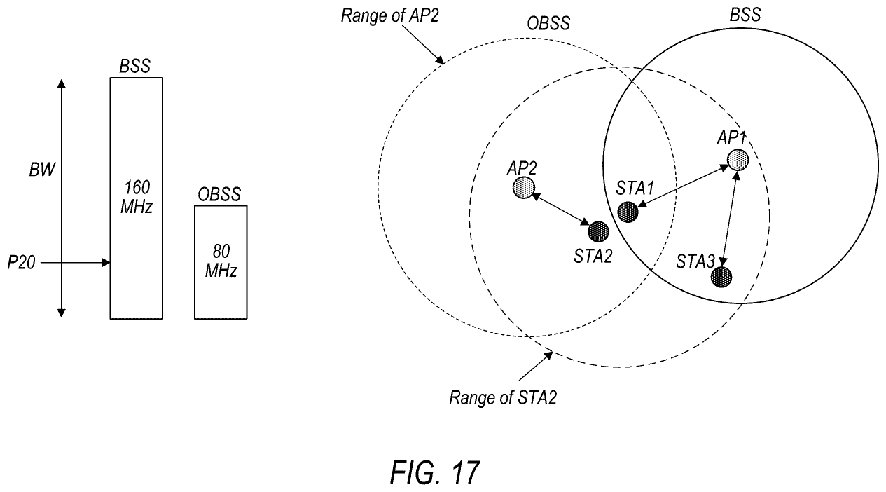

FIG. 17 illustrates example aspects of a yet further possible wireless communication system with overlapping BSS operation. In the illustrated example system, the BSS in which AP1, STA1, and STA3 operate is 160 MHz, and an OBSS (in which AP2 and STA2 operate) is 80 MHz (e.g., such that there is overlap on the P80 of the BSS). AP1/STA1/STA3 can hear both AP2 and STA2.

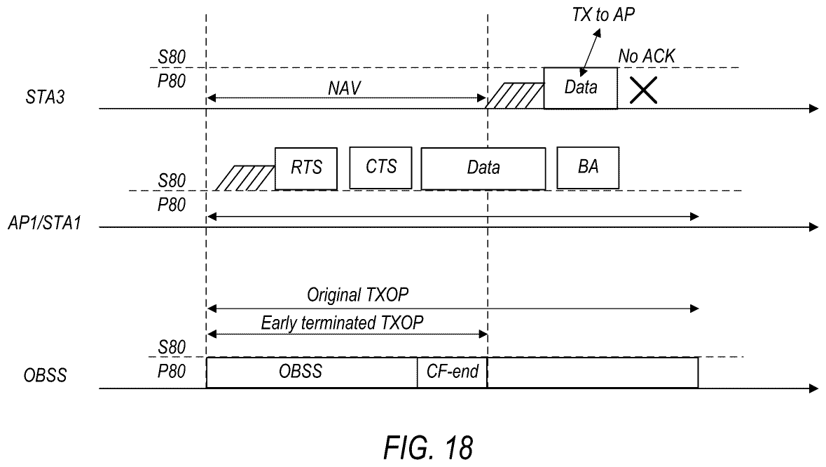

FIG. 18 illustrates example aspects of a possible scenario in which early termination of OBSS activity occurs during AP coordinated OSCA communication in such a system, according to some embodiments. In this example scenario, STA1, STA3, and AP1 have equal operating bandwidth. AP1/STA1/STA3 can set NAV by observing the TXOP between AP2 and STA2. AP1 and STA1 begin using S80 for AP coordinated OSCA, but AP2 and STA2 terminate their TXOP early, e.g., by sending a CF-END. STA3 resets its NAV by observing the early TXOP termination between AP2/STA2, e.g., based on receiving the CF-END. If, as shown, AP1 and STA1 continue to use S80 (e.g., with the NAV already set), STA3 may transmit on P80 to AP1 during the AP1/STA1 TXOP, resulting in a packet loss since AP1 may not be able to receive on P80 during the ongoing TXOP on S80. Thus, in the illustrated example scenario, AP1 and STA1 can successfully use S80, but STA3 data PPDU is lost, resulting in a regression for STA3.

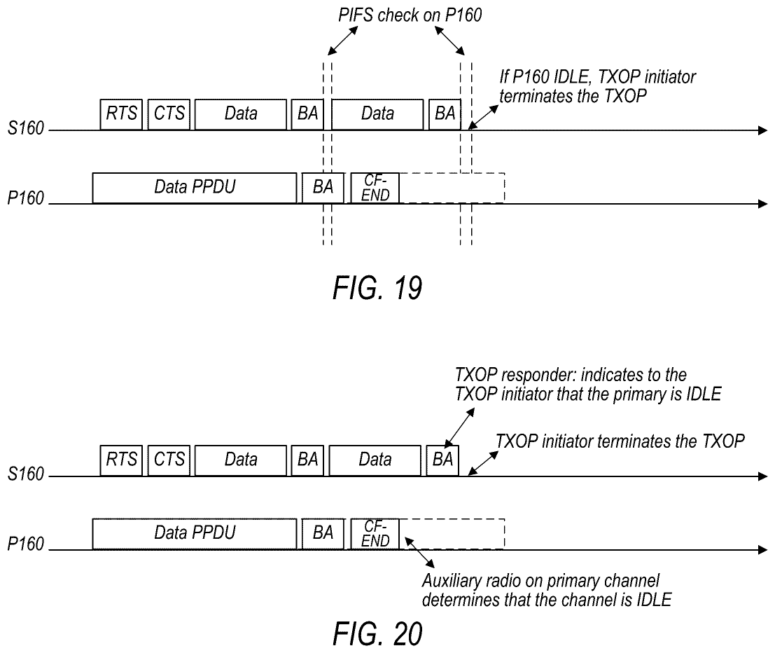

FIGS. 19-20 illustrate example aspects of possible scenarios in which the impact of such early termination of OBSS activity during AP coordinated OSCA communication could be mitigated, according to some embodiments. In some embodiments, the techniques used in these scenarios could be enabled/disabled, e.g., such that when a device is detecting a lot of early TXOP termination, the device could enable it, while when the device is experiencing little or no early TXOP termination, the device could disable it. In some embodiments, the techniques may be performed at the AP, or TXOP initiator for P2P scenarios (and could also apply to legacy STAs with different NAV observations). For example, the AP may have wider BSS coverage, better observation of primary clear channel assessment (CCA), and also may be better suited to handling the implementation complexity of the techniques, at least in some instances.

In the scenario of FIG. 19, the AP/STA may perform priority interframe space (PIFS) check on the occupied primary channel between each frame exchange (e.g., using main or auxiliary radio). If the PIFS check shows the primary channel as IDLE, the TXOP initiator can terminate the TXOP on the SC by sending CF-End or another (e.g., new) control frame.

In the scenario of FIG. 20, while receiving data PPDU, the TXOP responder can listen on the primary channel using an auxiliary radio. If the TXOP responder detects that the primary channel is IDLE, it will send an indication in the ACK to the TXOP initiator to terminate the TXOP. The TXOP initiator can then terminate the TXOP on the secondary channel by sending CF-End or another (e.g., new) control frame.

In cases in which the STA has smaller operating bandwidth than the AP, and the STA/AP intends to use the secondary channel within the BSS bandwidth for frame exchange (e.g., when the AP is 160 MHz, the BSS BW is 160 MHz, and the STA is 80 MHz; when the primary 80 MHz is BUSY, the STA/AP can use the S80 (upper 80 MHz) for frame exchange), it may be possible that similar techniques as for AP coordination for equal bandwidth scenarios also apply. In addition, at least in some instances, it may be the case that sufficient padding is included in the MU-RTS to support the channel switch of the STA to the secondary channel. The STA, upon receiving the MU-RTS on the secondary channel using the auxiliary radio and determining the bandwidth and TXOP duration of the secondary channel, can switch its main radio to the secondary channel.

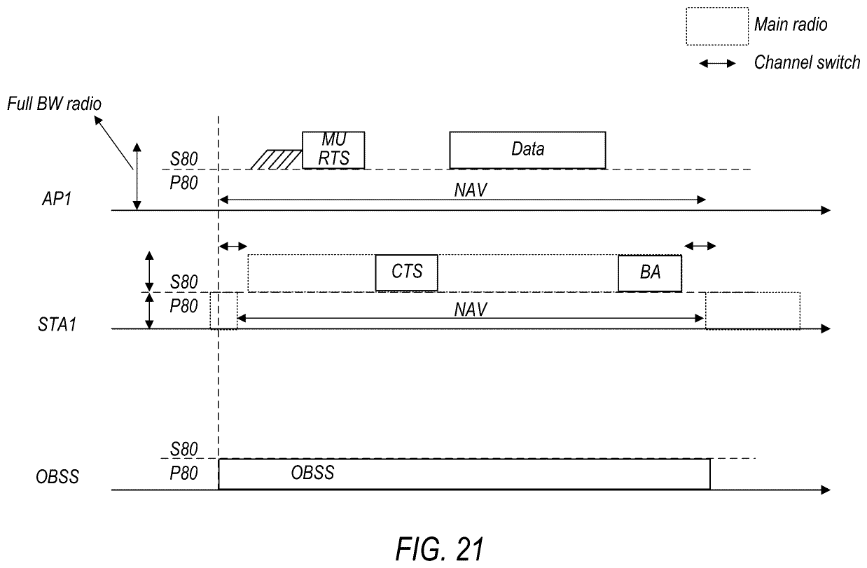

FIG. 21 illustrates example aspects of a possible scenario in which AP coordinated OSCA communication between an AP and a STA with smaller bandwidth could occur in the system of FIG. 7, according to some embodiments. In this example scenario, AP1 has 160 MHz bandwidth and STA1 has 80 MHz bandwidth. When STA2 sends a data PPDU, both AP1 and STA1 set the same NAV. As shown, AP1 contends and initiates a TXOP on S80 by sending a MU-RTS frame. STA1, after receiving the MU-RTS on S80, switches its channel from P80 to S80 and responds with a CTS frame. AP1 can finish its TXOP on S80 with some time margin to the end of the NAV to allow for channel switching time back to P80 for STA1. Before the ending of the NAV, STA1 can then switch its main radio back to P80.

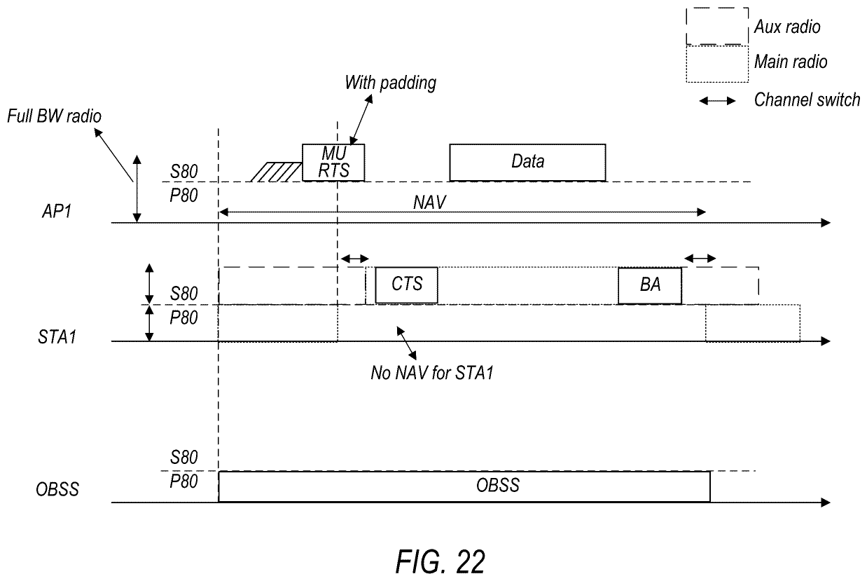

FIG. 22 illustrates example aspects of a possible scenario in which AP coordinated OSCA communication between an AP and a STA with smaller bandwidth could occur in the system of FIG. 10, according to some embodiments. An auxiliary radio may be used in this scenario, in which after MU-RTS reception on the primary channel, the main radio can switch from the primary channel to the secondary channel. Note that if the auxiliary radio of a STA is busy with other operations during the applicable time, it may be the case that it does not respond with CTS. In this example scenario, AP1 has 160 MHz bandwidth and STA1 has 80 MHz bandwidth. When STA2 sends a data PPDU, AP1 will set NAV, while STA1 will think the channel is clear. Thus, AP1 and STA1 have different NAV observations in this scenario. As shown, AP1 initiates a TXOP on S80 by sending a MU-RTS frame. STA1, after receiving the MU-RTS on S80 using the auxiliary radio, switches its channel from P80 to S80 to continue the TXOP on S80. After the end of the TXOP, STA1 channel switches to P80.

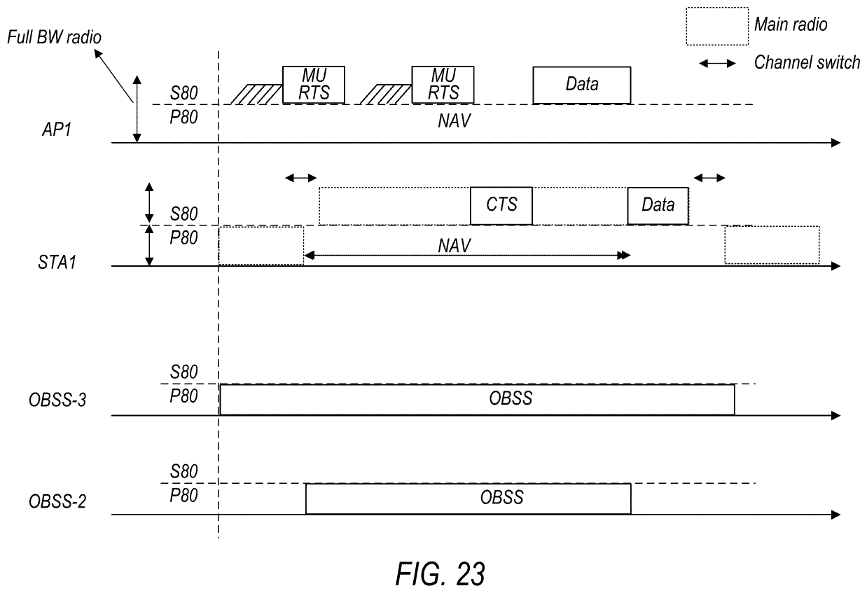

FIG. 23 illustrates example aspects of a possible scenario in which AP coordinated OSCA communication between an AP and a STA with smaller bandwidth could occur in the system of FIG. 13, according to some embodiments. In this example scenario, AP1 has 160 MHz bandwidth and STA1 has 80 MHz bandwidth. When AP2/STA2 and AP3/STA3 TXOPs overlap, AP1 sets the NAV based on AP3/STA3 and STA1 sets the NAV based on AP2/STA2. Thus, AP1 and STA1 both set NAV, but use different durations, in this example scenario. AP1 initiates the TXOP with STA1, and STA1 can follow the TXOP duration and bandwidth setting of the AP1 regardless of its NAV setting. Note that as in the scenario of FIG. 14, it may be possible that the TXOP duration can be adjusted by the STA1's CTS, or the STA1 can follow the TXOP duration of the AP1 without adjustment. Note similarly that if there is a different bandwidth observation between the AP1 and STA1, when AP1 initiates the TXOP, the STA1 can follow the bandwidth suggested by AP1 or ask for a smaller bandwidth, according to various embodiments.

As previously described herein, scenarios can occur in which an AP and STA that are about to engage in an OSCA TXOP have different preferences for the TXOP bandwidth and/or the TXOP duration. These situations could be due to different NAVs experienced by the respective sides, or could be due to local interference detected at the STA side, which the AP is unaware of. As one example, for a STA and AP with 160 MHz operating bandwidth, the AP could initiate an OSCA by sending a RTS/MU-RTS on the S80, but the STA, after assessing the S80 channel, could find the best response would be to send a CTS on part of the S80, e.g., the upper/lower 40 MHz of S80 or one of the 20 MHz subchannels. As another example, for a STA and AP with 320 MHz operating bandwidth, the AP could initiate an OSCA by sending an RTS/MU-RTS on the S160 and the STA could respond with a CTS on the S160 or any subset thereof, e.g., upper or lower 80 MHz portions, one or more of the 40 MHz sub-channels, or one or more of the 20 MHz sub-channels. A similar example could occur when the STA has a smaller bandwidth versus the AP, such as when the AP has 320 MHz operating bandwidth and the STA has 160 MHz operating bandwidth.

To accommodate bandwidth signaling for such scenarios (and/or other scenarios), it may be possible for the AP to include a new field in the MU-RTS that indicates the intended bandwidth for the upcoming transmission by the AP. The STA could include a new field in the CTS or new control response frame that indicates a subset of the bandwidth suggested by the AP in the preceding MU-RTS. Note that for adding a new field to the CTS frame, a new CTS frame may be created (e.g., a “UHR CTS”). Note that, while in IEEE 802.11ac, legacy RTS/CTS frames were modified so that 20/40/80/160 MHz bandwidth indication is possible, this signaling is limited in the maximum bandwidth, and the signaling only allows for indication of the subsets that include the P20 channel; in other words, in this type of signaling, out of several 20 MHz (or 40 MHz, or 80 MHz) sub-channels, it may be the case that only one is defined in this signaling.

For TXOP signaling, there could be cases where the TXOP initiator has a longer NAV than the TXOP responder, so there might be cases where the STA can decide to change the TXOP duration suggested by the AP. If the STA wants to change the TXOP duration (e.g., from the duration identified in the MU-RTS), it may be the case that the STA can update the duration in the CTS frame accordingly. Alternatively, the CTS frame may carry an additional duration field to indicate the maximum TXOP duration that the responding STA prefers. Other options are also possible.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
by a first wireless device:
detecting an overlapping basic service set (OBSS) transmission on a primary channel of a link between the first wireless device and a second wireless device; and
initiating a transmit opportunity (TXOP) with the second wireless device on a secondary channel of the link based at least in part on detecting the OBSS transmission on the primary channel of the link.

2. The method of claim 1, the method further comprising:
receiving an indication of a duration of the OBSS transmission; and
setting a network allocation vector (NAV) for the primary channel based at least in part on the indication of the duration of the OBSS transmission.

3. The method of claim 2, the method further comprising:
providing, to the second wireless device, an indication of a duration of the TXOP on the secondary channel; and
receiving, from the second wireless device, an indication to use a shorter TXOP duration for the TXOP on the secondary channel.

4. The method of claim 1, the method further comprising:
selecting a bandwidth for the TXOP on the secondary channel based at least in part on at least one of a bandwidth of the OBSS transmission or a signal strength of the OBSS transmission.

5. The method of claim 4, the method further comprising:
receiving, from the second wireless device, an indication to use a different bandwidth for the TXOP on the secondary channel or to stop the TXOP on the secondary channel based at least in part on the signal strength of the OBSS transmission.

6. The method of claim 1, the method further comprising:
using a furthest sub-channel of the secondary channel from the OBSS transmission on the primary channel as an anchor sub-channel of the secondary channel.

7. The method of claim 1, the method further comprising:
transmitting, to the second wireless device, an initial control frame (ICF) to initiate the TXOP on the secondary channel; and
receiving, from the second wireless device, a control response frame indicating to terminate the TXOP on the secondary channel.

8. The method of claim 1, the method further comprising:
determining that the primary channel of the link is idle during the TXOP on the secondary channel; and
transmitting a control frame indicating early termination of the TXOP on the secondary channel based at least in part on determining that the primary channel of the link is idle during the TXOP on the secondary channel.

9. The method of claim 1, wherein the second wireless device has a smaller operating bandwidth than the first wireless device, the method further comprising:
transmitting, to the second wireless device, an initial control frame (ICF) to initiate the TXOP on the secondary channel that includes padding configured for use by the second wireless device for channel switching from the primary channel of the link to the secondary channel of the link.

10. A processor comprising memory configured to cause the processor to perform operations comprising:
receiving, from a wireless device, an initial control frame (ICF) initiating a transmit opportunity (TXOP) on a secondary channel of a link with the wireless device;
generating a control response frame, wherein the control response frame is configured for transmission on the secondary channel of the link with the wireless device in response to the ICF.

11. The processor of claim 10, wherein the memory is further configured to cause the processor to perform operations comprising:
determining that an overlapping basic service set (OBSS) transmission is occurring on a primary channel of the link;
wherein the control response frame is generated based at least in part on detecting the OBSS transmission on the primary channel of the link.

12. The processor of claim 11,
wherein the ICF indicates a TXOP duration on the secondary channel,
wherein the control response frame includes an indication of a preferred TXOP duration that is different than the indicated TXOP duration.

13. The processor of claim 12, wherein the memory is further configured to cause the processor to perform operations comprising:
receiving an indication of a duration of the OBSS transmission; and
selecting the preferred TXOP duration based at least in part on the indication of the duration of the OBSS transmission, wherein the preferred TXOP duration is selected to not extend beyond the duration of the OBSS transmission.

14. The processor of claim 11,
wherein the ICF indicates a bandwidth for the TXOP on the secondary channel,
wherein the control response frame indicates a preferred bandwidth for the TXOP that is different than the indicated bandwidth for the TXOP on the secondary channel.

15. The processor of claim 14, wherein the memory is further configured to cause the processor to perform operations comprising:
determining a bandwidth of the OBSS transmission;
determining a signal strength of the OBSS transmission; and
selecting the preferred bandwidth for the TXOP on the secondary channel based at least in part on the bandwidth of the OBSS transmission and the signal strength of the OBSS transmission.

16. The processor of claim 15,
wherein the preferred bandwidth for the TXOP on the secondary channel is indicated by the control response frame using one of more of:
a transmission bandwidth of the control response frame; or
one or more fields of the control response frame configured to indicate the preferred bandwidth for the TXOP on the secondary channel.

17. A wireless device, comprising:
one or more antennas;
one or more radios operably coupled to the one or more antennas; and
a processor operably coupled to the one or more radios;
wherein the wireless device is configured to:
detect an overlapping basic service set (OBSS) transmission on a primary channel of a link with an access point (AP) wireless device;
receive, from the AP wireless device, an initial control frame (ICF) that initiates a transmit opportunity (TXOP) on a secondary channel of the link; and
transmit, to the AP wireless device, a control response frame on the secondary channel of the link.

18. The wireless device of claim 17,
wherein the ICF is received using an auxiliary radio of the wireless device, wherein the wireless device is further configured to:
switch a main radio of the wireless device from the primary channel of the link to the secondary channel of the link based at least in part on receiving the ICF on the secondary channel of the link,
wherein the control response frame is transmitted using the main radio of the wireless device.

19. The wireless device of claim 17, wherein the wireless device is further configured to:
determine that the primary channel of the link is idle during the TXOP on the secondary channel; and
transmit a control frame requesting termination of the TXOP on the secondary channel based at least in part on determining that the primary channel of the link is idle during the TXOP on the secondary channel.

20. The wireless device of claim 17,
determine to request to terminate the TXOP on the secondary channel based at least in part on received signal strength indicator (RSSI) measurement for the primary channel of the link,
wherein the control response frame indicates the request to terminate the TXOP on the secondary channel.
